(19) United States
(12) Patent Application Publication
(10) Pub. No.: US 2002/0101409 A1
(43) Pub. Date: Aug. 1, 2002

(54) Glass touch panel

(76) Inventors: Kiyohiro Yokoyama, Saitama (JP); Masatake Yoshida, Saitama (JP); Toshiaki Ishiyama, Saitama (JP)

Correspondence Address: WENDEROTH, LIND & PONACK, L.L.P., 2033 K STREET N. W., SUITE 800, WASHINGTON, DC, 20006-1021, US

(21) Appl. No.: 09/993,626

(22) Filed: Nov. 27, 2001

(30) Foreign Application Priority Data
Nov. 27, 2000 (JP) 2000-359678
Oct. 16, 2001 (JP) 2001-318587
Nov. 26, 2001 (JP) 2001-359390

(51) Int. Cl. G09G 5/00

(52) U.S. Cl. 345/173

(57) ABSTRACT

This invention provides a novel glass touch panel of extremely excellent in high temperature and high humidity proof, having an upper transparent glass substrate 1a and a lower transparent glass substrate 1b bonded to each other by an adhesive 6, hygroscopic fine particles mixed thereto.

### FIELD OF THE INVENTION

The present invention relates to a glass touch panel, and more particularly, to a novel glass touch panel of a glass/glass type which is extremely excellent in high temperature and high humidity proof and also has a merit of a narrow frame and thus is useful for various kinds of displays such as a car navigation display, a video camera display and a monitoring display.

### BACKGROUND OF THE INVENTION

There has often been used a touch panel for various kinds of displays such as a CRT display. The touch panel is capable of inputting by a fingertip or a pen.

The basic structure of the touch panel has a glass substrate, a transparent resin substrate above the glass substrate and conductive films on the surfaces of the glass substrate and the transparent resin substrate opposing each other. Also, spacers are optionally used between the glass substrate and the resin substrate.

However, the touch panel having such basic structure has been not always satisfactory in durability, environment proof and wear proof Further, clearness of the screen has not been satisfactory one and aging discoloration of the screen has been remarkable.

In view of these problem, there has been invented a glass touch panel (refer to JP1997-146707) capable of realizing excellent durability, environment proof and wear proof and also a beautiful screen and less discoloration and color shading. As show in FIG. 1, the glass touch panel has a pair of transparent substrates 1a, 1b, each having transparent conductive films 2a, 2b and opposed to each other at the transparent conductive film surfaces, wherein the upper transparent substrate 1a as a touch input portion is a glass substrate as well as the lower transparent substrate. It also has an extending wiring 4, a bonding means 5 and a silver electrode 7.

However, this prior art glass touch panel having such distinctive features still needs to be improved much more in temperature and humidity proof in order to meet the severe demands of various industries relating to displays. For example, as a display of navigation system for automobiles and such, high temperature and high humidity proof is required as much as possible.

### SUMMARY OF THE INVENTION

In view of the above, it is the main object of the present invention to provide a novel glass touch panel having excellent features such as excellent durability, environment proof and wear proof, a beautiful screen and less discoloration and color shading, as well as having extremely excellent high temperature and high humidity proof compared with the prior art glass touch panel.

### BRIEF DESCRIPTION OF TH DRAWINGS

The foregoing and other objects, features and advantages of the present invention will be better understood from the following detailed description, taken in conjunction with the accompanying drawings, in which:

FIG. 1 is a cross-sectional view showing the prior art glass touch panel.

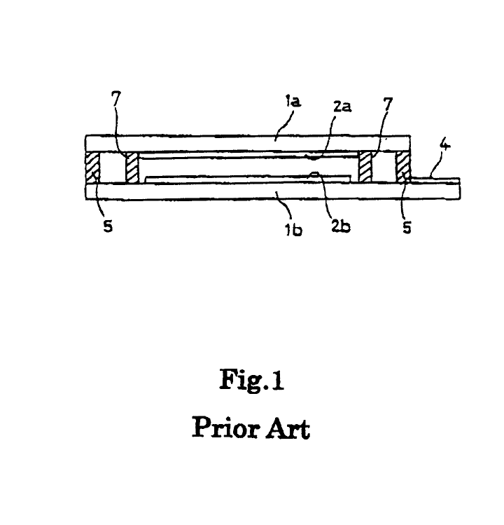

FIG. 2 is a cross-sectional view showing one example of the glass touch panel of the present invention.

FIG. 3 is a cross-sectional view showing another example of the glass touch panel of the present invention.

### DETAILED DESCRIPTION OF THE PREFERRED EMBODIMENTS

[Adhesive Blended with Hygroscopic Fine Particles]

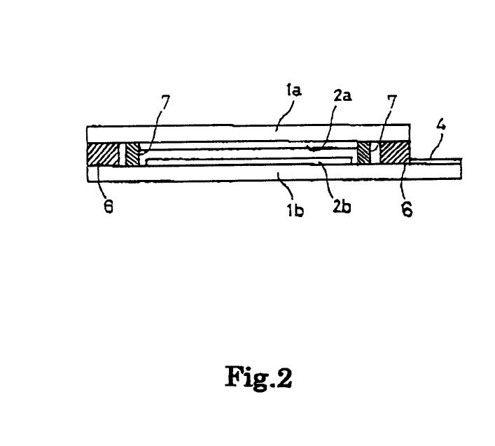

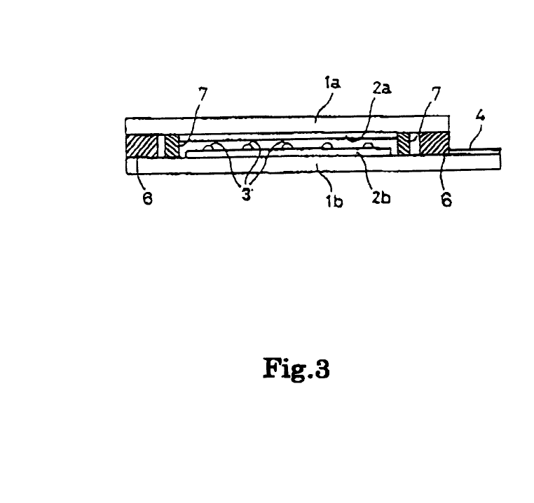

The glass touch panel of the present invention is a touch panel of a glass/glass type and is different from the conventional glass touch panel in bonding of the upper transparent glass substrate 1a and the lower transparent glass substrate 1b as shown in FIGS. 2 and 3.

As in FIGS. 2 and 3, the glass touch panel of the present invention has the upper transparent glass substrate 1a and the lower transparent glass substrate 1b, each having the transparent conductive films 2a, 2b and opposed to each other. The glass touch panel of FIG. 3 also has superfine particle dot spacers 3 on the transparent conductive film 2b of the lower transparent glass substrate 1b. The transparent conductive films 2a, 2b may be disposed in a suitable shape pattern.

Then, in the present invention, the upper transparent glass substrate 1a and the lower transparent glass substrate 1b are bonded and secured to each other by the use of an adhesive 6 mixed with hygroscopic fine particles, which are fine particles having hygroscopicity.

Therefore, since the hygroscopic fine particles in the adhesive 6 absorb humidity effectively, a humidity proof property much more excellent than that of the conventional panel can be attained even in an extremely high temperature condition. As has been already described the high temperature and high humidity proof property is extremely important in the use of a highly humidity condition, the glass touch panel of this invention can be used more preferably for a display and such of a navigation system in the inside of an automobile and such, for example.

The hygroscopic fine particles must exhibit full hygroscopic feature even in the adhesive 6. For example, fine silica-type particles having hygroscopic property can be used preferably as such particles. The size of the hygroscopic fine particles should not be limited in any way as long as they realize high temperature and high humidity proof while maintaining adhesiveness of the adhesive 6. However, from a viewpoint of the realization of still more effective coexistence of adhesiveness and high temperature and high humidity proof, for example, a diameter of 50 μm or less is preferable, a diameter of 5 to 50 μm is more preferable, and further a diameter of 5 to 10 μm is much more preferable. As for the mixing amount, although there is naturally a relation with the diameter size, it should not be limited in any way as long as the particles realize high temperature and high humidity proof property and maintain adhesive property of the adhesive 6 at the same time. However, for still more effective coexistence of the both properties, it is preferable to mix the particles with a weight ratio of 10% or less and more preferable with a weight ratio of 5% or less.

[Silver Electrode Blended with Glass Fiber]

As shown in FIGS. 2 and 3, in the glass touch panel of this invention, it is also preferable to use a silver electrode 7 mixed with a glass fiber. The silver electrode 7 is disposed at a predetermined position of the outer periphery of the upper transparent conductive film 2a and the lower transparent conductive fin 2b.

This silver electrode 7 mixed with a glass fiber can maintain the gap between the upper transparent conductive film 2a and the lower transparent conductive film 2b very much reliably, thereby realizing extremely excellent smoothness and preventing screen distortion and unevenness in the image quality and also interference infringes much more effectively than the conventional glass touch panel.

From the viewpoint of realizing sill more effective smoothness, it is preferable to mix the glass fiber into the silver electrode 7 with a weight ratio of 10% or less and also to use a silver paste having a electric resistivity of 5.0×10⁻⁴ Ωcm or less for the silver electrode 7.

[Performance and Characteristics of Glass Touch Panel]

Additionally, the glass tough panel of the present invention as described above should have the following required performance and characteristics. Of course, the glass touch panel of the invention can easily achieve such high performance and characteristics.

Among all, the light transmittance should be extremely favorable. That is, the light transmittance of 85% or more is preferable and 90% is more preferable. Such high transmittance can provide a beautiful screen.

Next, the operation temperature should preferably be −30 to 65° C., under the condition of 90%RH or lower and the preservation temperature on the condition with no dewing should preferably be −40 to 85° C. (12 hours) under the condition of 95%RH. Further, as for the humidity proof (humidity resistance), the glass touch panel should attain 1000 hours under the condition of 60° C.−95%RH. Furthermore, the glass touch panel should attain the heat resistance at 85° C. and the cold resistance at −30° C.

As for the mechanical characteristics, the glass touch panel should generally have the operation load of 10 to 200 g when the switch becomes a conduction state by pressing the upper transparent glass substrate 1a with a test rod having its top end R of 4 mm, diameter of 8 mm φ and hardness of 60°. The surface hardness should be 5 to 7 Mohs hardness.

Referring to the heat cycle as the durability index, the glass touch panel should operate over 200 cycles, one cycle comprising consecutive procedures of leaving it for 1 hour in an atmosphere of −30° C. and then leaving it for 0.5 hour at a room temperature (or normal temperature) and further leaving it for one hour in an atmosphere of +85° C. and then leaving it for 0.5 hour at a room temperature (or normal temperature).

In addition, an inactivation gas or air may be injected just before sealing in order to prevent occurrence of interference fringes as well as to smooth the recovery of glass (so called bounce) after input. Further, the operation load may be controlled by measuring it with a tension gauge in order to suit for various purposes. In this case, for example, it is preferable to make the bounce 10 msec or less for an ordinary operation method with a finger.

From a viewpoint of the material for the panel, borosilicate glass or soda glass having a thickness of from 0.15 mm to 0.3 mm may be preferably used for the upper transparent glass substrate 1a. And, for example, the upper transparent glass substrate 1a by borosilicate glass may preferably have physical properties as in the following Table 1.

TABLE 1
[Physical properties of the upper glass substrate]

| | |
|---|---|
| Heat expansion coefficient | 70 to 80 × 10⁻⁷/° C. |
| (0 to 300° C.) | |
| Young's modulus | 7 to 8 × 10⁹ kg/mm² |
| Poison ratio | 0.20 to 0.24 |
| Knoop hardness | 590 to 615 KHN₁₀₀ |
| Density | 2.30 to 2.85 |
| Distortion point | 480 to 520° C. |
| Gradual cooling point | 520 to 580° C. |
| Softening point | 700 to 750° C. |
| Volume resistivity | 8 to 10 log ρΩ cm |
| Dielectric characteristic | |
| (1 Mhz, at 20° C.) | |
| Dielectric constant | 6 to 8 |
| Loss | 0.2 to 0.6 |
| Refractive index | 1.5 to 1.54 |

Commercial products can be used for such glass having the above properties.

As for the lower transparent glass substrate 1b, soda glass having a thickness of from 0.5 mm to 3.0 mm may be preferably used.

Further, as for the transparent conductive films 2a, 2b disposed to such glasses 1a, 1b, thin films of ITO, tin oxide and such, especially, those formed by sputtering and chemical vapor deposition (CVD) may be preferably used. ITO may also be vapor-deposited on deposition of SiO₂ and such. This vapor deposition is a preferred method with regard to the adhesion property and uniformness property of the film.

In the case where the superfine particle dot spacers 3 are disposed as shown in FIG. 3, it is preferable to use a spacer formed by a thermosetting resin and having a diameter of from 20 to 100 μm, a height (=dot thickness) of from 3 to 6 μm and an inter-dot pitch of from 2 to 4 mm.

Electrical properties as a touch panel may preferably be as shown in the following Table 2.

TABLE 2
[Electrical properties of the glass touch panel]

| | |
|---|---|
| Rating | DC 5 V, 50 mA or less |
| Insulation resistance | DC 25 V, 10 MΩ or more |
| | (between upper and lower electrodes) |
| Linearity | ±3.5% or less |
| Bounce | 10 msec or less |
| | (by ordinary finger operation) |
| Antistatic voltage withstanding | 15 kV or higher |
| Dynamic range | Lower limit: 0 to 0.7 V, |
| | Upper limit: 5 to 4.6 V |

[Method of Manufacturing the Glass Touch Panel]

Hereinafter, a method for manufacturing the glass touch panel of this invention will be explained. For example, the glass touch panel of FIG. 3 can be manufactured according to the steps [1] to [6] described below.

Step 1. Formation of transparent conductive films 2a, 2b of ITO and such onto transparent glass substrates 1a, 1b by sputtering and CVD.

Step 2. Patterning of the transparent conductive films 2a, 2b by resist ink printing, film etching and resist ink peeling or by photo-lithography.

Step 3. Formation of superfine particle dot spacer 3 by resist ink printing and thermosetting or by photo-lithography.

Step 4. Formation of silver electrode 7 by grass fiber mixing, silver paste printing and baking.

Step 5. Printing of adhesive 6 by hygroscopic fine particles mixing and printing and temporal baking or by photo-lithography.

Step 6. Bonding of transparent glass substrates 1a, 1b.

The glass touch panel of this invention to be provided by the above manufacturing steps has an excellent high temperature and high humidity proof owing to the adhesive 6 blended with hygroscopic fine particles and an excellent smoothness owing to the silver electrode 7 blended with glass fibers thereby realizing characteristics of freeness from screen distortion, image-quality unevenness and interference infringes and further of extremely less discoloration and aging change of screen.

It is preferable that the adhesive 6 blended with the hygroscopic fine particles is used as a thermosetting or room-temperature epoxy-type sealant or UV setting acrylic-type sealant. For the thermosetting sealant, temporal baking is needed, and for the UV setting sealant, UV irradiation is needed. As already described, the hygroscopic fine particles must present high temperature and high humidity proof even in these sealants while maintaining the adhesive property of these sealants.

Of course, the glass touch panel of FIG. 2 having an excellent high temperature and high humidity proof and an excellent smoothness can be manufactured as well by the steps 1, 2, 4, 5 and 6 excluding the step 3.

### EXAMPLE

A glass touch panel as shown in FIG. 3 was manufactured actually by the following steps 1 to 6. The main dimensions thereof are as the following Table 3.

TABLE 3
[Main dimensions of the panel]

| | | |
|---|---|---|
| Upper transparent glass substrate 1a | 0.2 | mm thickness |
| Lower transparent glass substrate 1b | 1.1 | mm thickness |
| Outer size: | 140 × 85 | mm |
| Operation area size: | 130 × 59 | mm |

Step 1. Formation of ITO Thin film

At first, transparent zinc boresilicate glass is adopted as the upper transparent glass substrate 1a and soda glass is adopted for the lower transparent glass substrate 1b, and ITO thin films having a film thickness of from 100 to 200 Å and a surface resistance of 500 Ω/□ (ohms per square) are formed as the transparent conductive films 2a, 2b by sputtering and CVD. The transparent zinc borosilicate glass and the soda glass commercially available as a substrate for a thin film were used.

Step 2. ITO Patterning

Next, the following treatments are conducted sequentially as ITO patterning.

Pre-cleaning by supersonic waves

Coating of resist ink by screen printing

Baking at 120° C. for 30 min.

Etching of ITO with nitrate

Peeling of the resist ink by an alkali

Post cleaning using supersonic wave

Step 3. Formation of Superfine Particle Dot Spacer 3

Next, the following treatments are conducted sequentially for the formation of superfine particle dot spacers.

Coating of thermosetting resist-ink by printing with a metal mask

Baking at 200° C. for 60 min. so as to obtain a dot diameter of 20 μm, a dot thickness of 5 μm and a dot pitch of 3 mm.

Step 4. Formation of Silver Electrode 7

Next, the following treatments are conducted sequentially as formation of silver electrodes.

Stirring of glass fiber in silver paste with a weight ratio of 1.2%

Printing of the silver paste

Baking at 180° C. for about 60 min.

Step 5. Printing of Thermosetting Epoxy-Type Sealant as Adhesive 6

Next, the following treatments are conducted as printing of thermosetting epoxy-type sealants.

Stirring of silica-type fine particles having a diameter of 10 1 m with a weight ratio of 2.5%

Seal printing by thermosetting epoxy-type sealant

Temporal Baking at 90° C. for about 30 min.

Step 6. Bonding

As the final step, the upper transparent glass substrate 1a and the lower transparent glass substrate 1b are bonded by the following procedures.

Bonding by coating minute amount of the silver paste to contact points

Setting of curing jig.

Baking at 150° C. for about 90 min. and Cooling gradually

Cutting

Injection of air

Sealing by UV adhesive

By the above manufacturing steps, a glass touch panel having the following performances and characteristics in Table 4 was obtained.

TABLE 4
[Performances and Characteristics]

| | |
|---|---|
| Driving system | Analog system |
| Writing method | Finger or pen |
| Light transmittance | 85% (550 nm) |
| Operation temperature | −30 to 65° C. (90% RH or less) |
| Humidity proof | 1000 hours (60° C. −95% RH) |
| Heat cycle | 250 cycle (−30° C., +85° C.) |
| Heat resistance | 85° C. |
| Operation load | 80 g |
| Surface Mohs hardness | 6 |
| Rating | 0.8 mA (DC 5 V) |
| Insulation resistance | 12 MΩ (DC 25 V) |
| Linearity | +2.0% |
| Bounce | 8 msec |

For comparison, a prior art glass touch panel was manufactured by using the steps disclosed in JP1997-146707 and its performances and characteristics are shown in Table 5. This prior art panel has the same outer size and operation area size as the above panel of this invention, which are 140×85 mm and 130×59 mm.

TABLE 5
[Performances and Characteristics]

| | |
|---|---|
| Driving system | Analog system |
| Writing method | Finger or pen |
| Light transmittance | 85% (550 nm) |
| Operation temperature | −10 to 60° C. (90% RH or less) |
| Humidity proof | 140 hours (60° C. −95% RH) |
| Heat cycle | 15 cycle (−30° C., +80° C.) |
| Heat resistance | 83° C. |
| Operation load | 100 g |
| Surface Mohs hardness | 6 |
| Rating | 0.8 mA (DC 5 V) |
| Insulation resistance | 12 MΩ (DC 25 V) |
| Linearity | +3.0% |
| Bounce | 8 msec |

As apparent from Tables 4 and 5, the glass touch panel of this invention thus made is extremely excellent in the operation temperature, the humidity proof the heat cycle and the heat resistance compared with the prior art glass touch panel. Consequently, a glass touch panel having an extremely improved environmental proof (resistance) is realized, and such panel is very much suitable to the inner environment of a vehicle. It is need less to say that this panel is suitable not only for the inside of the car, but also for various situations at high temperature and high humidity. Of course, the panel thus made is free from distortion, unevenness and interference fringes on the screen and in the image quality.

As described above in detail, the invention can provide a novel glass touch panel having extremely excellent characteristics such as of durability, operationability, freeness of the design and input accuracy, as well as being extremely excellent in high temperature and high humidity resistance and in smoothness compared with the prior art glass touch panels.

What is claimed is:

1. A glass touch panel comprising a pair of transparent glass substrates, each having a transparent conductive film and also opposed to each other at the transparent conductive film surface, wherein the upper transparent glass substrate as a touch input part and the lower transparent glass substrate are bonded by an adhesive mixed with hygroscopic fine particles.

2. A glass touch panel as in claim 1, wherein each of the hygroscopic fine particles has a diameter of 50 μm or less.

3. A glass touch panel as in claim 1 or 2, wherein the hygroscopic fine particles are mixed to the adhesive with a weight ratio of 10% or less.

4. A glass touch panel as in any one of claims 1 to 3, wherein a silver electrode mixed with a glass fiber is disposed at a predetermined position on an outer periphery of the transparent conductive film.

5. A glass touch panel as in claim 4, wherein the glass fiber is mixed to the silver electrode with a weight ratio of 10% or less.

6. A glass touch panel as in claim 4 or 5, wherein a silver paste having a electric resistivity of 5.0×10⁻⁴ Ωcm is used for the silver electrode.

7. A glass touch panel as in any one of claims 1 to 6, wherein the adhesive is a thermosetting or room temperature setting epoxy type sealant or UV setting acrylic type sealant.

8. A glass touch panel as in any one of claims 1 to 7, wherein a light transmittance is 85% or more.

9. A glass touch panel as in any one of claims 1 to 8, wherein an operation temperature is from −30 to 65° C. under the condition of 90% RH or less.

10. A glass touch panel as in any one of claims 1 to 9, wherein a storing temperature is from −40 to 85° C. under the condition of 95% RH or less.

11. A glass touch panel as in any one of claims 1 to 10, wherein an operation load when a switch is in a conductive state by pressing the upper transparent glass substrate with a test rod having a top end R of 4 mm, a diameter of 8 mmφ and a hardness of 60° is from 10 to 200 g.

12. A glass touch panel as in any one of claims 1 to 11, wherein superfine particle dot spacers made of a thermosetting resin, each having a diameter of from 20 to 100 μm and a height of from 3 to 6 μm, are disposed at a pitch of from 2 to 4 mm on the transparent conductive surface of the lower transparent glass substrate.

13. A glass touch panel as in any one of claims 1 to 12, wherein the upper transparent glass substrate comprises borosilicate glass or soda glass having a thickness of from 0.15 to 0.3 mm, and the lower transparent glass substrate comprises a soda glass having a thickness of from 0.5 to 3.0 mm.

14. A glass touch panel as in any one of claims 1 to 13, wherein the transparent conductive film is deposited by vapor deposition in a predetermined shape with sputtering or chemical vapor deposition.

15. A glass touch panel as in any one of claims 1 to 14, wherein a rating is 50 mA or less for DC 5V and an insulation resistance is 10 MΩ or more between the upper and lower electrodes for DC 25V.

16. A glass touch panel as in any one of claims 1 to 15, wherein a linearity is ±3.5% or less.

17. A glass touch panel as in any one of claims 1 to 16, wherein a bounce by an ordinary finger operation method is 10 msec or less.

18. A glass touch panel as in any one of claims 1 to 17, wherein an electrostatic withstand voltage is 15 kV or more.

19. A glass touch panel as in any one of claims 1 to 18, wherein a dynamic range is from 0 to 0.7 V at the lower limit and from 5 to 4.6 V at the upper limit.

20. A glass touch panel as in any one of claims 1 to 19, wherein a size of the transparent glass substrate is 2 to 20 in.
